(19) United States
(12) Patent Application Publication
(10) Pub. No.: US 2010/0218128 A1
(43) Pub. Date: Aug. 26, 2010

(54) Offer And Incentive Widget-Based System

(76) Inventors: Michelle M. Bonat, Half Moon Bay, CA (US); Stephan A. DeRodeff, Groveland, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/713,138

(22) Filed: Feb. 25, 2010

Related U.S. Application Data
(60) Provisional application No. 61/155,488, filed on Feb. 25, 2009.

(51) Int. Cl. G06Q 30/00; G06F 3/048; G06Q 10/00; G06Q 99/00

(52) U.S. Cl. 715/765; 705/14.13; 705/14.16

(57) ABSTRACT

In an aspect there is provided a method. The method may include generating, at a processor, a campaign including an offer and a referral, the offer and the referral included in a widget; and providing, at the processor, the widget including the offer and the referral to one or more media types including a social network. The method may also include creating campaigns through rules based interaction of target end-users, real time analytics (which may include the identification of influencers), and dynamic updates of in-flight campaigns. Related systems, methods, and articles of manufacture are also described.

### CROSS REFERENCE TO RELATED APPLICATION

This application claims the benefit under 35 U.S.C. §119(e) of the following provisional application, which is incorporated herein by reference in its entirety: U.S. Ser. No. 61/155,488, entitled “OFFER AND REFERRAL SYSTEM,” (Attorney Docket No. 39124-501P01US) filed Feb. 25, 2009.

### FIELD

The subject matter described herein relates to web-based advertising.

### BACKGROUND

In the past, promoting a brand typically required deploying an advertising campaign on a few media types, such as television, radio, and print, and then measuring the success of the campaign. With the rise of the Internet, promoting the brand has become more complex. First, the types of available media have increased dramatically. For example, a campaign may not only include the traditional outlets of television, radio, and print but also include the Internet class of media types, such as email, blogs, websites, newsletters, videos (e.g., placed on YouTube and the like), and social networking sites (e.g., Facebook, Twitter, MySpace, and the like). This broad array of media types has not only made deployment exceedingly difficult but also made measurement of the impact of the campaign more difficult. There is thus an opportunity to enhance the mechanisms for generating, deploying, and measuring campaigns.

### SUMMARY

In an aspect there is provided a method. The method may include generating, at a processor, a campaign including an offer and a referral, the offer and the referral included in a widget; and providing, at the processor, the widget including the offer and the referral to one or more media types including a social network.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

In the drawings,

FIG. 1A depicts an example of a widget;

FIG. 1B depicts process flow for dynamic updating;

FIG. 2 depicts a system for generating a campaign including a widget;

FIG. 3 the interaction of a target user with a campaign including a widget;

FIG. 4 depicts an example of a template used to generate a widget;

FIG. 5 depicts a page generated by the system and presented to a user to manage a campaign by, for example, configuring goals for the campaign including the widget 100;

FIG. 6 depicts another example of a system for generating a campaign including a widget; and

FIG. 7 depicts some of the functionality which may be included in the system of FIG. 6.

Like labels are used to refer to same or similar items in the drawings.

### DETAILED DESCRIPTION

The system described herein may be implemented using any media type including social networking forms of web interaction to enable an entity to create campaigns targeting end-users, such as target customers and/or a current customers, to allow the target user to receive an offer and complete the requirements of the offer in order to obtain the benefit of the offer. As used herein, the phrase “target” refers to an entity which is the target of the campaign and/or the widget. On the other hand, the term “user” refers to a user of the system developing, generating, modifying, and the like the campaign and/or the widget deployed to targets over one or more media types.

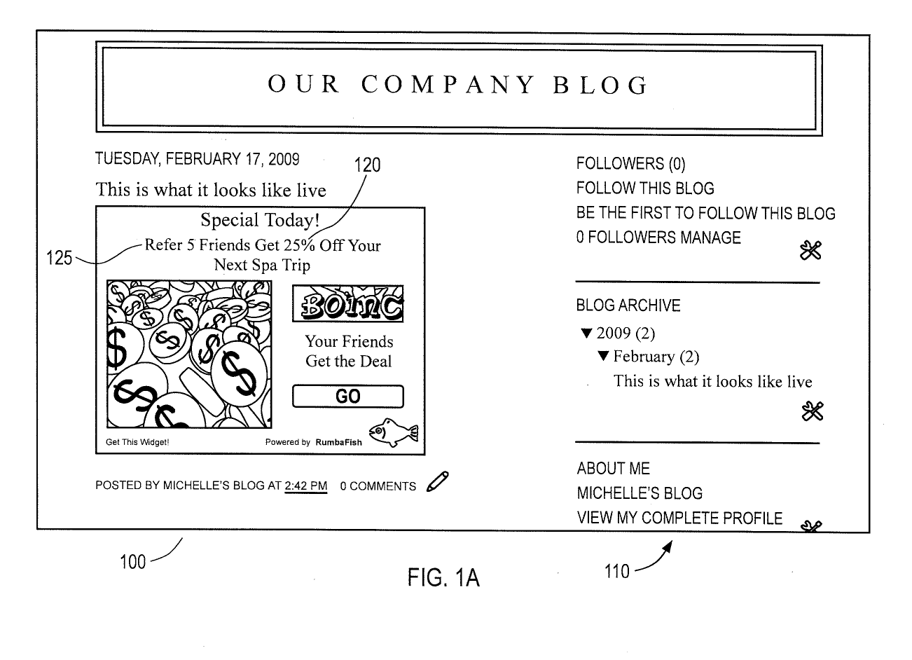

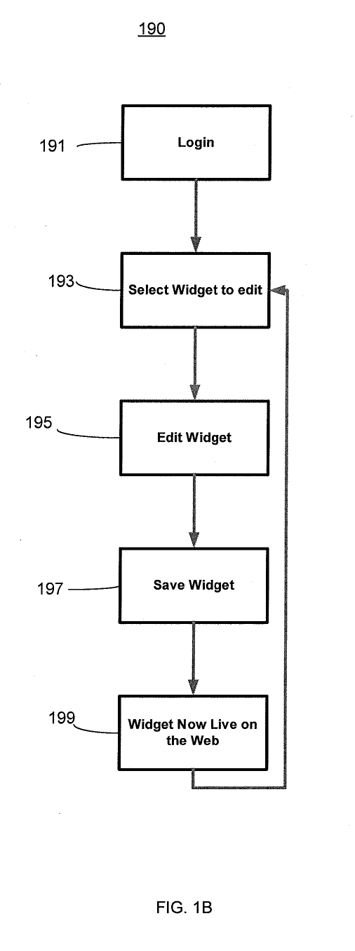

The system may generate and/or provide a widget to a user interface, such as a computer, a browser, and the like, for presentation. An example of a widget is depicted at FIG. 1A. The term “widget” refers to a relatively small, portable application, which can be placed into a web page or a browser and can be written in a variety of languages (e.g., Java, .NET, PHP, HTML, and the like).

In some implementations, the system described herein addresses the problem of deploying one or more unique, interactive marketing campaigns using different types of media. Campaigns (which may include widgets, offers, and/or other marketing instruments) are generated by the system described herein (based on a one or more inputs from a user), and the resultant code that is generated can be used in a variety of media types, such as websites, emails, newsletters, blogs, and social networks. The system may generate the code for a dynamic widget to be placed on a web page and/or for a hyperlink directly into the campaign. The campaigns may then be deployed over one or more media types, without requiring additional user input.

The system described herein also may provide what is referred to as dynamic update. For example, the system may enable a user of the system to modify a campaign (e.g., on the system's website), save the modifications to the campaign, and deploy (e.g., provides and/or sends) the modification to the targets over the Internet to one or more media types in real-time with a single click to allow a target to interact with and/or view the modified campaign. The modifications may include any aspect of the campaign. For example, the modification to a campaign may include changing the offer, changing a behavior required to obtain an incentive (e.g., sending an email to friends or posting a message on social networks), and adding items to a campaign or a widget (e.g., adding graphics, logo, text, offer content, colors, a fulfillment web page providing details regarding the rules/requirements for satisfying an offer).

FIG. 1B depicts a process 100 for dynamic updates to a campaign and/or a widget. At 191, a user accesses the system described herein (e.g., system 600, etc.) with a login which may request a user identifier and password. At 193, a widget associated with a campaign may be selected for modification. For example, the widget 100 may be selected and presented to a user at a user interface. At 195, the selected widget may be modified by a user (e.g., a customer) at the user interface. For example, the widget may be modified to include a different offer and/or different images, although other modifications may be implemented as well. At 197, the modified widget is saved in a storage mechanism. At 199, the widget is deployed (e.g., provided, sent, and the like) to one or more targets via one or more media types including websites, social media, email, and the like. For example, the widget can be deployed by placing the generated code into a website of a company using the system (or by an affiliate marketing partner of the company), linking into a newsletter sent to target customers, directly placing the widget or a link into social networks and/or online advertisements and web applications. The system may then proceed to make measurements, as noted above, of the modified widget to allow generation of analytic reports.

The system described herein may also provide the ability for a user to define rules which determine whether a campaign is fulfilled. For example, the rules may include how many referrals must be made by a target to receive an offer of the campaign and/or widget, whether a social network post is required by the target to fulfill an offer, and the like. Moreover, additional rules may be defined and implemented in a campaign. The rules-based aspect of the system described herein may also provide for control of a target's interaction by requiring a behavior and then providing feedback when the required behavior is not performed by the target. For example, the target for a campaign or a widget may be offered a 10% discount when a social network post is made mentioning the product and the offer is forwarded to a friend, i.e., another target. The rules enable the system described herein to influence and thus control the target's behavior regardless of the media type.

In some implementations, the system described herein may also include analytics. For example, analytics may measure the speed, the reach, the impact, and the influencers (e.g., targets accessing the campaign and those influenced by the targets) associated with a campaign and/or a widget, thus providing information and a mechanism to modify the campaign, even during the campaign (referred to as “in-flight”) to optimize and improve the performance of the current and/or a subsequent campaign. Moreover, the measurements may be performed and displayed in real-time during the campaign.

The system described herein may also collect information as a target clicks on the widgets, web pages, emails, and the like associated with the campaign. The collected information on the target's behavior may include what the target does on the web page, did the target make a purchase, when was the purchase made, did the target click through to a web page or surf away from that web page, which individuals received communication from the target, which of those responded, and which completed the required behaviors, and the like. This collected information may then be analyzed by the system described herein and presented to the user as for example a real-time analytic report. The real-time analytic report may be updated as the behavior of the target(s) occurs and/or changes. The real-time analytic report data may be presented at a user interface, such as an online dashboard for the user of the system, and/or may be downloaded into a data containers, such as an Excel file.

Referring to FIG. 1A, the widget 100, when presented at a user interface, includes an offer 120 and the requirements 125 needed to receive the benefit of the offer. FIG. 1A also depicts that widget 100 is incorporated into a social networking web site, as evident by the blog 110. In the example, the offer contains an incentive, e.g., 25% off, and a requirement to obtain the offer, e.g., refer 5 friends. The system (described further below with respect to systems 200 and 600) includes components to enable a user to access the system, generate the widget including the offer and the requirement (e.g., referral of friends), and provide the widget (or other mechanisms of the campaign), so that it can be used to make offers to targets (e.g., the user's customers and/or potential customers). The system also includes components to manage and/or measure aspects of the campaign. For example, the system may include offer tracking, click through tracking, and/or tracking the identity of the targets including friends influenced by the targets.

Although FIG. 1A depicts the widget 100 including an offer of 25% and a requirement of 5 friends, this is an example since other types of widgets, offers, and requirements may be used as well. The widget 100 may include the offer 120. Moreover, the widget 100 may be placed on a server, a website, a newsletter hosted on a website or sent as an email, a social networking website, and the like. The widget 100 may be configured at the system to include text and graphics describing the offer and include links to a website (e.g., where additional details may be obtained regarding the offer, product, and the like). In some implementations, widget 100 is configured to include multiple languages including, for example, Adobe's Flex, HTML, and the like.

The system described herein may also include, as noted above, components to manage and/or measure the impact of campaigns and their associated widgets (which are provided to its users), track usage of the campaigns, and the like. For example, the system may allow an entity to manage ad campaigns for its customers by generating the campaign and tracking the offers and usage of the offers included in the campaign. Moreover, this management may include tracking when the referrals are made and to whom the referrals are made. For example, a target may receive an offer and to obtain the incentive may forward the offer to 5 friends via an email or a social network forum. In this example, the system may track the identity of the target, the 5 friends, whether purchases were made, what was purchased, when the purchases were made, the click through behavior of the target and 5 friends, and the like.

The system may be implemented to include a server (e.g., a website), at which a campaign may be generated, configured (e.g., customized, as well as configuring an ad campaign including goals for the campaign), and/or measured.

The widget 100 may also be configured to include links, which can be placed in ads, web pages, brochures, emails, social networking forms, and/or documents of any kind. The widget 100 may also include offer completion and cancel links, which direct the user to web pages denoted by the company (making the offer) upon successful completion of the offer criteria or upon cancellation of the interaction. The system may also store (e.g., gather and retain) goals for offers and campaigns. For example, a goal for an offer can include the number of influencers engaged (e.g., how many targets engage the offer), total friends shared with (e.g., how many offers this influencer sent to their friends), and total friends registered (e.g., how many of their friends clicked through and registered on the system 600, described below, to receive the offer). The system may, as noted above, collect offer results and analytic reports comparing goals to the actual results achieved.

The system may also be configured to bring a target to a website via a link included in the widget 100. When this is the case, information may be collected about the target, which in this example is a customer interested in the offer of the widget generated by the system. The collected information may include demographic and/or personal information about the target as well as information about other potential target customers referred by the target. For example, the user may refer 5 friends by providing names and email addresses. The website may be configured to enable a target customer to register (e.g., create a user login and provide demographic and personal information) to receive additional offers. The system may also be configured to allow the target customer to return the offeror's website and receive the benefit of the offer. For example, in widget 100, the target customer may be directed to the website of the spa. The system may also be configured to allow an offer to be canceled and then direct the target customer to a specific page of the website (e.g., a landing page indicating that the offer is canceled or has expired). The system may also include a referral generation component for sending emails including offers to the referrals made via the widget 100 (e.g., emails to the 5 friends).

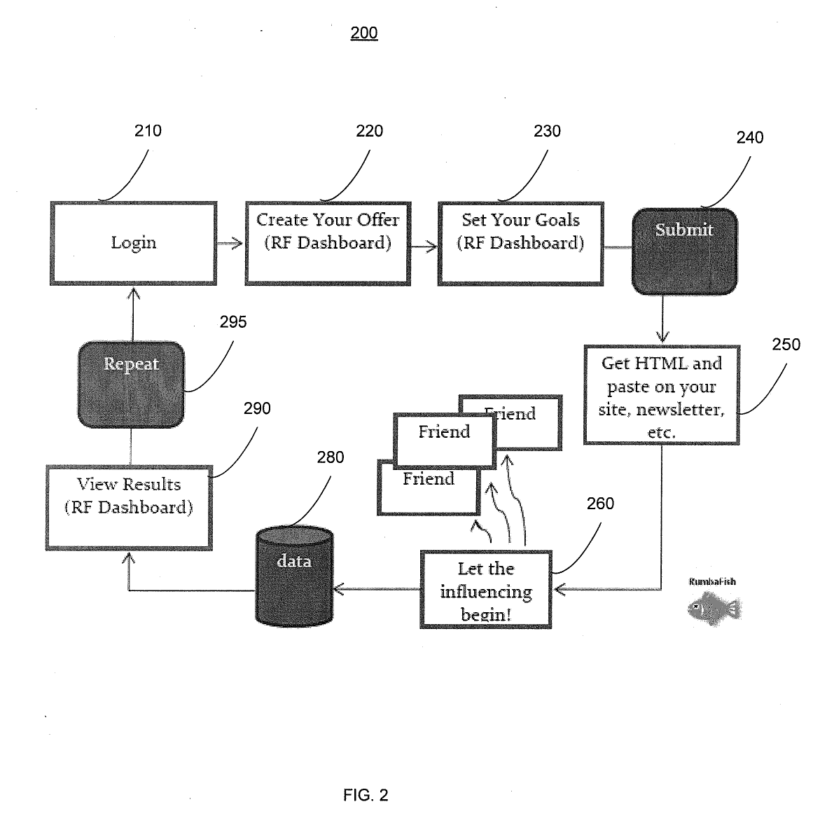

FIG. 2 depicts a process 200 for generating and deploying a widget, such as widget 100, associated with a campaign. The process 200 may be implemented on a system including one or more processors (e.g., computers coupled to the Internet and/or any other network) and one or more memory.

At 210, a user via a user interface logins (e.g., providing a user identifier and password) into the system for generating and providing widgets.

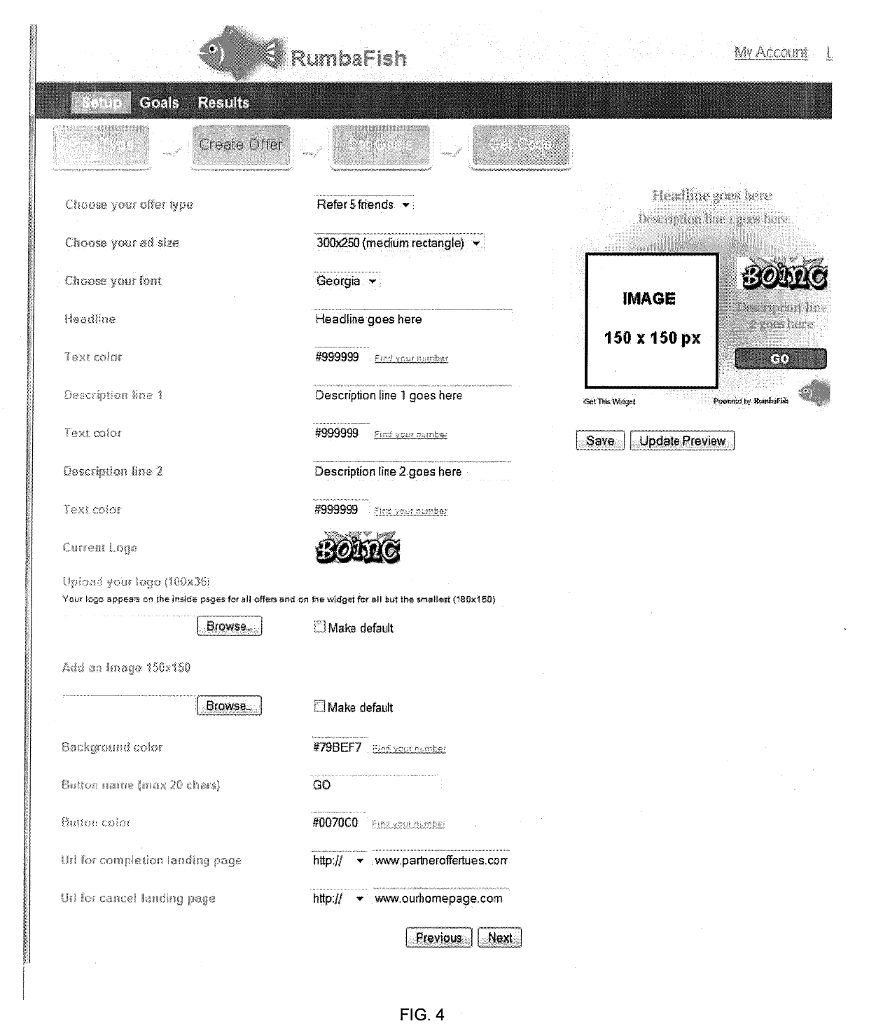

At 220, the system generates a page for presentation at a user interface. The page is referred to as a so-called “dashboard.” At the dashboard, a user enters information to create an offer of a campaign (e.g., create a new offer, copy a previous offer, edit a previous offer, obtain code from a previous offer, and the like). For example, the system may include one or more templates to allow a user to create an offer for use with the widget. FIG. 4, described further below, depicts an example of a template used to configure (e.g., generate, create, etc.) the widget 100. Moreover, the system may facilitate widget generation by allowing one or more of the following objects/aspects of the widget to be configured: a type of offer, a size of the widget, a design, a font, a logo, and images presented by the widget, a headline, a text, colors, and the like. The user, e.g., a user generating the widget at system 100, may also indicate a location or link, such as a Uniform Resource Locator, where the user interacting with the completed widget 100 is directed upon successful completion or cancellation of an interaction with the widget 100 including the offer.

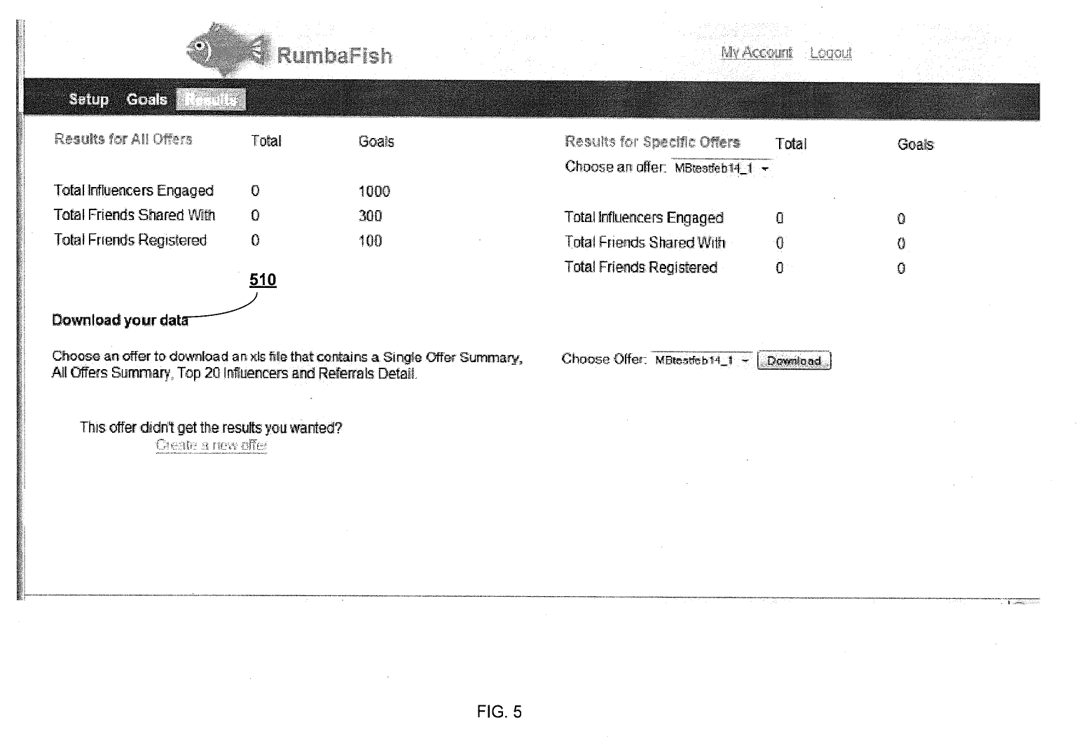

At 230, the user may also set goals for the campaign including the offer via the dashboard provided by the system. Goals may be established and then stored at a database at the system. The goals are set based on a number of parameters. For example, the dashboard may allow a user to set one or more goals for the target(s), such as total influencers engaged, total friends shared with, and total friends registered, all of which are stored in connection with the widget 100 and offer. FIG. 5, described further below, depicts a page generated by the system and presented by a user interface to a user to configure goals for the widget 100 (including the offer) and/or a campaign associated with the widget 100.

Referring to FIG. 2, at 240, the completed widget is then submitted for storage, so that it can be used. Once the widget 100 including the offer contained in the widget is created, the user may, at 250, retrieve the code of the widget 100 to embed the widget into a website, a newsletter, an online communication, such as a social networking website, or any other media type. The user may also use the code to link to online without embedding this code by using the links provided by the system. For example, when this link (which is generated at system 600) is used instead of a widget embedded in a web site or web page, the link bypasses the widget and leverages the backend functionality of system 600 without having to place the widget on a website. Moreover, a company generating and/or making the offer can use this link functionality to embed system 600 features into newsletters, online ad campaigns, and other media types.

At 260, the widget 100 may be used to influence the behavior of one or more targets. For example, the widget 100 includes an offer and an incentive (e.g., refer 5 friends). This offer and incentive is more likely to influence the target's behavior when compared to a simple ad. The system may track and store at database 280 the activity associated with the widget (e.g., whether a target provides referrals, whether the referrals also refer widget 100 to five other friends, whether a target makes a purchase using the offer, etc.). Moreover, measurements may be made based on the tracked information to enable generation of analytic reports.

At 290, the system 100 may provide analytic reports (e.g., HTML pages and/or files) to the originating user of the widget (e.g., the user that generated the widget 100 including the offer and incentive), wherein the analytic reports track the activity (e.g., results) associated with the widget 100. In some implementations, the tracking and analytic reports represent information obtained in real-time. The process 200 may be repeated as depicted at 295.

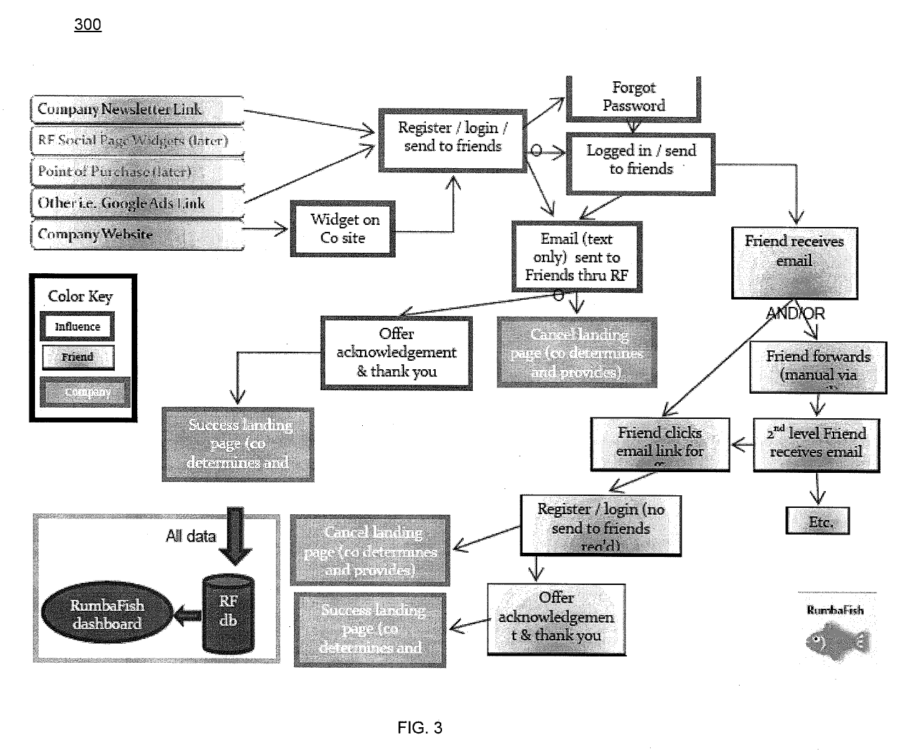

The following further illustrates how a target presented with widget 100 or other campaign mechanism engages the system. One or more of the following aspects are depicted at a process 300 at FIG. 3. For example, the target engages a company's website (or, e.g., other online mechanisms including a link in a company newsletter, online ad, an embedded widget in a social networking page, and a point of purchase). Once the target engages, the system provides the target with a widget 100 including an offer (as well as what must be done to receive the offer). The system also provides the mechanisms for the target to provide the required information or to perform any action required to complete and accept the offer. Targets interacting with the system may register with a web server (e.g., web server 665) associated with the system. For repeat targets to the system, the target visiting the system may be provided a streamlined interaction process with the system (e.g., an initial access may require the target to provide detailed information, such as personal information and demographic information, while a subsequent visit by the target may only require a user identifier and password). For repeat targets that need a password prompt or reset, the system provides that as well.

Once the target is registered or logins to the system, the customer may be presented with a page (e.g., as a fulfillment page or portion of a page in a web browser, etc.) with the information required to receive the offer. For example, if the offer gives a discount in return for referring 5 friends, the user interface receive from the system a page to invite those friends. The system tracks and validate that this invitation is done correctly. The offer may include standard information as well as information specific to each offer.

When the target has completed the parameters to invite friends, the system sends widgets including the offers to the invited friends (e.g., by email, posts on social networks, text, instant messaging, and the like). The invited friends receive the email including an indication that they have received the email from their friend, details of the offer, and what the friend needs to do to also receive the offer. For example, in the case of the “refer five friends” offer included in widget 100, the friend receiving the offer must also complete the parameters of the offer (e.g., send it to five other friends) to receive the offer themselves. To complete the offer parameters, the referred friend may be required to register or login into the system. This provides for an ever-expanding circle of referrals. Once the friend (and referred friends) successfully completes the offer parameters, the friends are directed (i.e., the web browser is directed) to the URL that has been specified by the company (e.g., the company associated with the spa) setting up the widget 100 including the offer. If the offer is cancelled, these customers may be directed back to the URL specified by the company for that offer. Information representative of the activity associated with the widget including the offer is stored in a database (e.g., a relational database configured on a computer including memory and physically stored on a computer-readable storage medium). As noted above, the information may be presented as a page (e.g., a dashboard) to the user generating the widget (e.g., 290 at FIG. 2). The system may also include behavior-enhanced analytics, such as data mining, to predict interactions with a widget including the offer.

FIG. 4 depicts an example of a template provided by the system to allow a user to create a campaign including an offer and generate the associated widgets. The system may allow a user to select a type of offer (e.g., refer 5 friends, posting a message on a social networking site) or other types of offers, such as sweepstakes, signups, surveys, and the like. The system also allows a user generating the widget to choose one or more aspects of the widget including: size of the widget (or ad); font type; headline; text color; descriptive text; a logo; an image; background color; button names; button color; URL for completion (e.g., when a customer completes the information referring 5 friends); and a URL for cancellation (e.g., when the offer of the widget is canceled). In some implementations, the system provides the template of FIG. 4 as a page at 220 of FIG. 2. As noted above, the system may also allow dynamic updating to the campaign and/or the widget, so that modification may be made and redeployed to the targets over various media types.

FIG. 5 depicts a page that may be provided to a user at 290. The page includes results (which may be included in an analytic report) of the campaign including one or more of the following: total influencers engaged, total friends shared, total friend visits, total friends engaged, and the like. It may also include the results of the campaign on social networks such as Twitter, Facebook, LinkedIn, and MySpace. The results may be for a specific widget including an offer or for a plurality of offers being controlled by a user. The page may also include an indication of a goal set by a user. For example, a user may have a goal of engaging with 5,000 targets for an offer, having the targets share with friends with a ratio of 1:5 (which would engage 25,000 target friends), and then have a goal for how many of those friends registered with the system (e.g., system 600) to receive the offers, which could be 25% of these or 5,000. Moreover, the page of FIG. 5 may allow a user to download data at 510 or view it in real-time. The data can be downloaded into a spreadsheet across a number of parameters. These parameters may include: a summary report for one offer initiated by the user along the metrics of total influencers engaged, total friends shared with, and total friends registered; a similar report for all offers initiated by the user in summary; a list of the top 20 influencers that offer which includes identifying information associated with how many friends each have shared offers with, which can be ranked on a most frequent basis; and a detailed list of referral information which includes the name and email address for each individual target that has been involved in the offer with an identifier for how they were involved (e.g., as an influencer, a friend, or a registered friend).

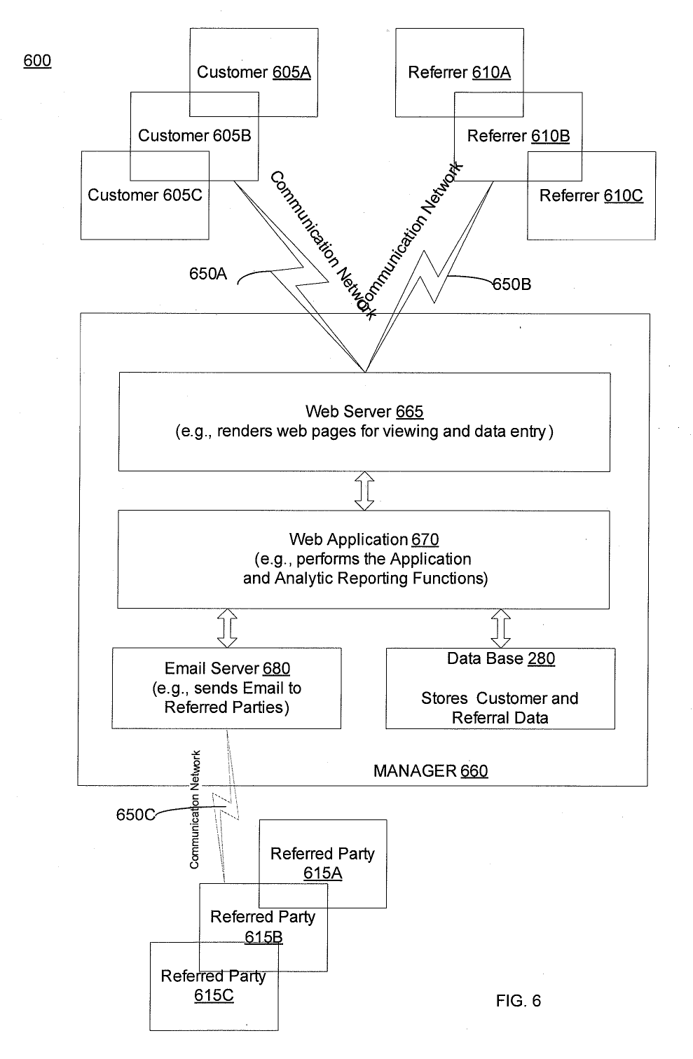

FIG. 6 depicts an example implementation of a system 600 for providing a widget, such as widget 100 including an offer. The system 600 includes users, depicted as customers 605A-C, referrers 610A-C, and referred parties 615A-C. The system 600 further includes manager 660, which further includes a web server 665, a web application 670, an email server 680, and a database 280. The users and manager 660 are coupled by a communication link, such as communication network 650A-C.

Although the customers, referrers, and referred parties may be the same entity, the customer 605A-C refers generally to a user generating a widget including an offer to be used in an ad campaign. The customer 605A-C may include a processor, e.g., a computer, mobile device, smart phone, etc, memory, and a user interface, such as a web browser, client application, and the like to interact with manager 660 via the communication network.

The referrers 610A-C refers generally to a target who elects to view the widget 100 including the offer. The referrers 610A-C may include a processor, e.g., a computer, mobile device, smart phone, etc, memory, and a user interface, such as a web browser, client application, and the like to interact with manager 660 via the communication network.

The referred party 615A-C is generally a target that elects to view widget 100 including the offer sent by a referrer. The referred party 615A-C may include a processor, e.g., a computer, mobile device, smart phone, etc, memory, and a user interface, such as a web browser, client application, and the like to interact with manager 660 via the communication network.

The manager 660 may include web server 665. The manager 660 may be implemented using a computer (e.g., a processor including memory) configured with an operating system, such as Linux, Windows server, UNIX, Java, and the like. The web server 665 is configured to generate pages (e.g., FIGS. 4 and 5) to allow a user to generate the widget 100 and track the activity associated with the widget 100 and perform processes (e.g., processes 200 and 300). The web server 665 is thus configured to accept and respond to requests and to provide for viewing and collection of information from the above-described users. The information collected may include information required to create, manage, and track a single widget including an offer and/or campaigns as well as information needed to complete offers, including customer email addresses, referral email addresses and names, personal messages, and the like.

The manager 660 may further include web application 670. The web application 670 may be implemented using a computer (e.g., a processor including memory) configured with an operating system, such as Linux, Windows server, UNIX, Java, and the like. The web application 270 is configured to execute code which embodies the business logic, process flow, business rules, look and feel of the processes described herein (e.g., one or more aspect of process 200 at FIG. 2 and/or process 300 at FIG. 3), manage storage, and retrieve information gathered by the system 600.

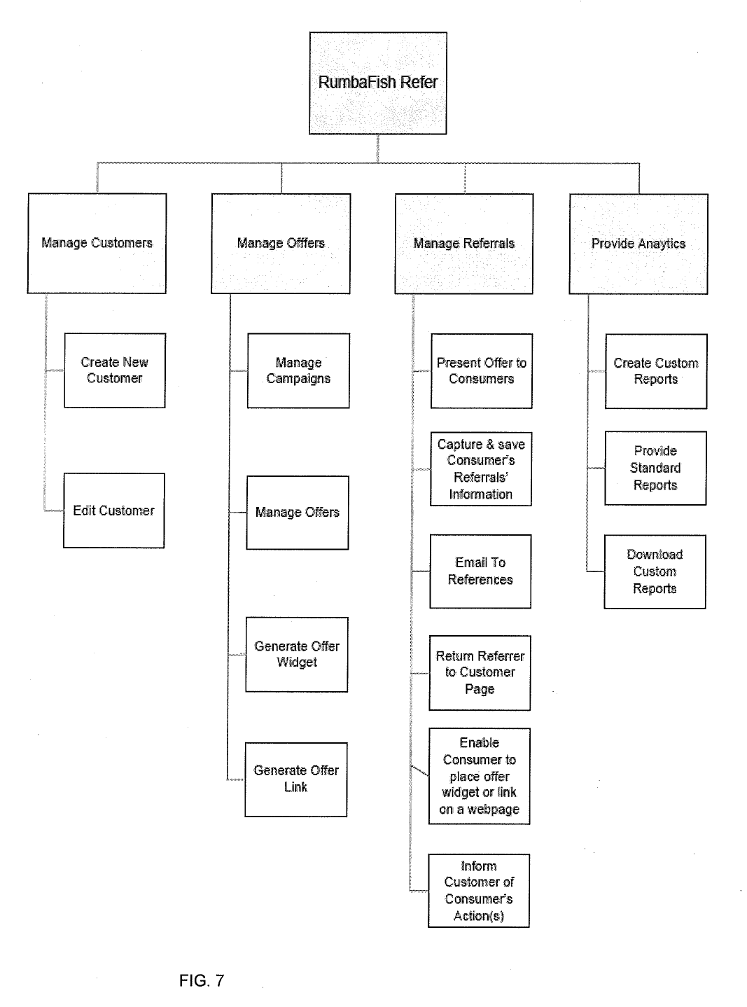

FIG. 7 depicts some of the functions, which may be included in web application 670. The web application 670 may manage customers, manage the offers included in a campaign, manage offers referred to other users, and provide analytics.

Referring again to FIG. 6, the database 280 may be implemented on a processor and include a storage medium and a database management system for managing data stored on the storage medium. The database provides persistent storage for system 600 to allow access by the web application 670 for the purpose of presenting or gathering information to a user to drive generation of widgets or its associated campaign. For example, the content and structure of the campaigns as well as the ownership, activity, lifecycle, outcomes and objectives of the campaigns may be stored.

The manager 660 may further include an email server 680. The email server 680 may be implemented using a computer (e.g., a processor including memory) configured with an operating system, such as Linux, Windows server, UNIX, Java, and the like. The email server 680 may be implemented with a wide variety of standalone or service provided email systems including but not limited to Microsoft Exchange, IMAP Mail, SMTP servers, or any combination thereof. The email server 680 sends emails to users (e.g., referred parties 215A-C from their referrers 610A-C), and the emails may include information about customer offers as well as system 600. For example, the email may contain a personal message from the referring customer, a description of the offer, and instructions as to how to obtain the offer.

Communication network 650A-C may be any type of communications mechanism and may include, alone or in any suitable combination, the Internet, a telephony-based network, a local area network (LAN), a wide area network (WAN), a dedicated intranet, wireless LAN, an intranet, a wireless network, a bus, or any other communication mechanisms. Further, any suitable combination of wired and/or wireless components and systems may provide communication network 650A-C. Moreover, communication network 650A-C may be embodied using bi-directional, unidirectional, or dedicated networks. Communications through network 650A-C may also operate with standard transmission protocols, such as Transmission Control Protocol/Internet Protocol (TCP/IP), Hyper Text Transfer Protocol (HTTP), SOAP, RPC, or other protocols.

The system 600 may be used to establish a user, which will generate a campaign including the widget 100 and/or its associated widgets. For example, the system 100 may be used to collect user information such as name, address, billing information, contact information, etc; to enable changes to a user's information; and to enable users to set up and manage a campaign including an offer and/or widgets (as well as multiple types of campaigns). As noted, the campaign refers to one or more widgets including offers as well as other campaign mechanisms. For example, system 600 may be used to create a campaign, duplicate a previous campaign, edit a campaign, and complete a campaign.

The system 600 may be used to allow a user to set up and manage offers included in the widget 100. For example, multiple type offers can be managed by manager 660. Moreover, manager 660 may be used to generate an offer for a campaign; create/read/update/delete (CRUD) offer start/end dates; CRUD targets/goals, CRUD coupons/tokens; CRUD offer text; CRUD offer URLs associated with a canceled offer or a completed offer; image(s); CRUD setup landing page/widget; generate offer widget; generate the code for an offer widget to be placed on a user's web page or other web accessible location; enable the user to copy the offer widget 100 code; generate a link for the offer; generate a link for placement on a user's website, in an email, on a personal web page, or other website; enable the user to copy the link; report and provide analytic reports/services based on the user's campaigns; show campaign statistics by campaign and by offer; download offer results (e.g., email addresses, names, dates, level, top 20 influencers, etc.); enable a user's customer (e.g., a so-called “target customer”) to complete an offer, navigate to an offer, capture the required information for the offer (multiple names and email addresses), propagate the offer by sending the offers to the target user's referrals via email, save the target customer offer actions, data entered, and allow the target customer to return to a website of the user making the offer (e.g., customer 605A); providing acknowledgement to the customer 205A that an offer's requirements have been fulfilled; allow target customer 205A to place offer widget on their personal social networking page; allow a target customer 205A to grab widget and provide the ability for a user to dynamically update the widgets on the target customer's page

The subject matter described herein may be embodied in systems, apparatus, methods, and/or articles depending on the desired configuration. In particular, various implementations of the subject matter described, such as the components of base stations, client stations, macrodiversity controller, and processes described herein, may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. For example, the components of system 600, and aspects of processes 200 and 300 described herein may be realized in digital electronic circuitry, integrated circuitry, specially designed ASICs (application specific integrated circuits), computer hardware, firmware, software (including computer programs), and/or combinations thereof.

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed:

1. A method comprising:
generating, at a processor, a campaign including an offer and a referral, the offer and the referral included in a widget; and
providing, at the processor, the widget including the offer and the referral to one or more media types including a social network.

2. The method of claim 1, wherein providing further comprises:
providing the widget to one or more targets regardless of a media type being used by each of the one or more targets.

3. The method of claim 1, further comprising:
selecting the widget previously provided to one or more targets; and
editing the selected widget before redeployment to the one or more targets via the one or more media types.

4. The method of claim 2, further comprising:
editing the selected widget to modify the widget, the modification comprising at least one of a text object of the widget, a graphical object of the widget, and one or more rules associated with obtaining the offer.

5. The method of claim 1, further comprising:
generating a report including information representative of one or more behaviors of one or more targets of the widget.

6. A system comprising:
at least one processor; and
at least one memory; wherein the at least one processor and the at least one memory provide operations comprising:
generating, at a processor, a campaign including an offer and a referral, the offer and the referral included in a widget; and
providing, at the processor, the widget including the offer and the referral to one or more media types including a social network.

7. The system of claim 6, wherein providing further comprises:
providing the widget to one or more targets regardless of a media type being used by each of the one or more targets.

8. The system of claim 6, further comprising:
selecting the widget previously provided to one or more targets; and
editing the selected widget before redeployment to the one or more targets via the one or more media types.

9. The system of claim 7, further comprising:
editing the selected widget to modify the widget, the modification comprising at least one of a text object of the widget, a graphical object of the widget, and one or more rules associated with obtaining the offer.

10. The system of claim 6, further comprising:
generating a report including information representative of one or more behaviors of one or more targets of the widget.

11. A computer-readable storage medium including code which when executed by at least one processor provides operation comprising:
generating, at a processor, a campaign including an offer and a referral, the offer and the referral included in a widget; and
providing, at the processor, the widget including the offer and the referral to one or more media types including a social network.

12. The computer-readable storage medium of claim 11, wherein providing further comprises:
providing the widget to one or more targets regardless of a media type being used by each of the one or more targets.

13. The computer-readable storage medium of claim 11, further comprising:
selecting the widget previously provided to one or more targets; and
editing the selected widget before redeployment to the one or more targets via the one or more media types.

14. The computer-readable storage medium of claim 12, further comprising:
editing the selected widget to modify the widget, the modification comprising at least one of a text object of the widget, a graphical object of the widget, and one or more rules associated with obtaining the offer.

15. computer-readable storage medium of claim 11, further comprising:
generating a report including information representative of one or more behaviors of one or more targets of the widget.
